(19) United States
(12) Patent Application Publication
(10) Pub. No.: US 2004/0216257 A1
(43) Pub. Date: Nov. 4, 2004

(54) Wiper system

(76) Inventors: Thomas Weigold, Baden-Baden (DE); Jan Dietrich, Buehl (DE); Armin Stubner, Buehl-Altschweier (DE); Claus Fleischer, Buehl (DE); Oralando Gabriel De Dias, Karlsruhe (DE); Johannes Moosman, Tennenbronn (DE); Hartmut Krueger, Buehlertal (DE)

Correspondence Address: MICHAEL BEST & FRIEDRICH, LLP, 100 E WISCONSIN AVENUE, MILWAUKEE, WI, 53202, US

(21) Appl. No.: 10/477,654

(22) PCT Filed: Feb. 18, 2003
(86) PCT No.: PCT/DE03/00483

(30) Foreign Application Priority Data
Sep. 12, 2002 (DE) 102 42 304.0

(51) Int. Cl. B60S 1/26; B60S 1/16

(52) U.S. Cl. 15/250.3; 15/250.16

(57) ABSTRACT

Windshield wiper apparatus, in particular for a motor vehicle, with a drive motor and at least one gear that drives at least one wiper arm, whereby the at least one gear is equipped with at least one device to inhibit the at least one gear.

The invention relates to a windshield wiper apparatus, in particular for a motor vehicle, with a drive motor and at least one gear that drives at least one wiper arm.

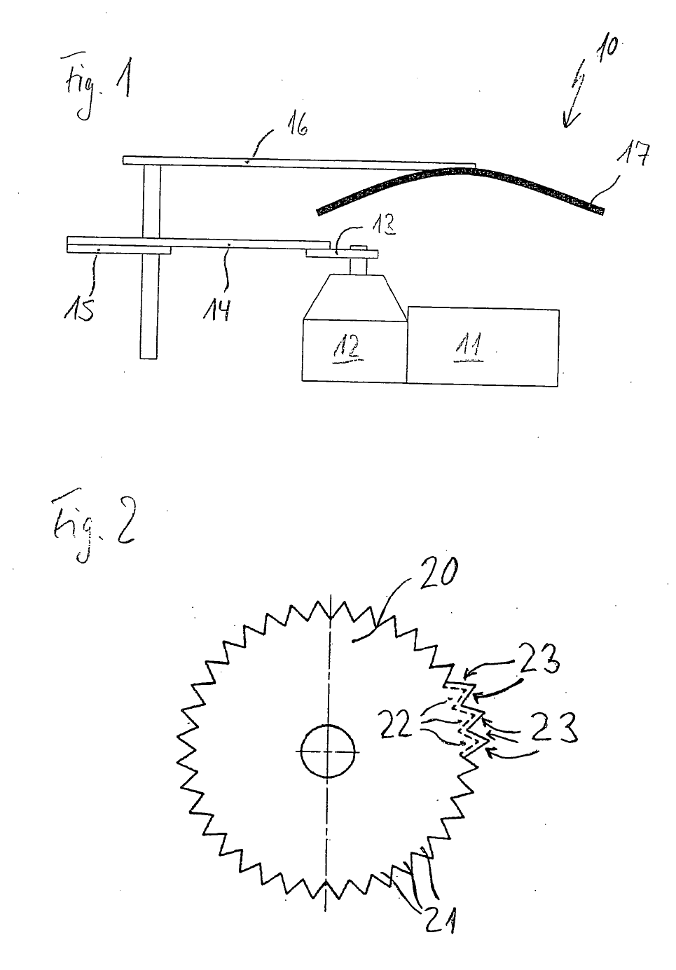

FIG. 1 shows windshield wiper apparatus 10 known from the state of the art. A drive motor 11 drives a wiper arm 16 on which a wiper blade 17 is attached via a toothed wheel gear 12 and a crank 13, which is connected with an oscillating crank 15 by means of a coupler 14. It is disadvantageous that the toothed wheel gear 12 is not self-locking so that it could also be moved by moving the wiper arm 16, if the crank 13, the coupler 14 and the oscillating crank 15 were not connected between the wiper arm 16 and the toothed wheel gear 12. The crank 13 along with the coupler 14 and the oscillating crank 15 serves to convert the rotational movement of the toothed wheel gear 12 into a pendulum motion, which enables the wiper blade 17 to move back and forth on the vehicle windshield. When the two reversing points of the wiper blade 17 are reached on the vehicle windshield, the crank 13 and the coupler 14 are aligned in a line so that no torque can be exerted on the crank 13 by moving the wiper blade 17, and the wiper blade 17 cannot swivel out of its momentary position due to an external effect of force. This is desirable particularly when the wiper blade is in its parked position, i.e., when the windshield wiper apparatus is not in operation and the wiper blade is supposed to be kept stably in its parked position by the external effect of force, e.g., at high vehicle speeds, which exert a high wind force on the wiper blade 17. Instead of the combination of a crank 13 and an oscillating crank 15 to convert the rotating motion into a pendulum motion, a reversing motor is frequently used, which periodically alters its rotational direction in accordance with the pendulum motion of the wiper blade. Thus, when using a reversing motor it is possible to dispense with the combination of the crank 13 and the oscillating crank 15. However, it is disadvantageous in this case that then the wiper blade can easily be misadjusted by the external effect of force, since the frictional forces of the toothed wheel gear and the drive motor are too low to compensate for the external forces acting on the wiper blade.

The object of the invention is improving a windshield wiper apparatus of the type mentioned at the outset so that even when the combination of crank and oscillating crank is eliminated, the wiper blade is kept securely in its parked position when external forces are acting on the wiper blade.

The invention attains the undertaken object by a windshield wiper apparatus, in particular for a motor vehicle, with a drive motor and at least one gear that drives at least one wiper arm, whereby the at least one gear is equipped with at least one device to inhibit the at least one gear. As a result, in the future the wiper blade can be kept securely in its parked position even if there are great external forces acting on the wiper blade even when using a reversing motor or if a crank downstream from the toothed wheel gear is not aligned in a line with the associated coupler when the wiper blade is in the parked position.

The at least one device to inhibit the at least one gear can be realized very simply if the at least one gear features a gear worm in which a toothed wheel engages and the toothed wheel features a projection on at least one front side. In the parked position, this projection can rub, e.g., on the gear housing or on another non-rotating part within the gear housing so that these frictional forces counteract the external force acting on the wiper blade thereby preventing the wiper blade from undesirable swiveling.

The gear housing can also feature a projection, which, in the parked position of the at least one wiper arm, forms a frictional connection with the projection on the toothed wheel. Such projections that are attached on the toothed wheel and the gear housing can be realized structurally in a very easy manner. They do not require any additional parts on the wiper motor so that no additional expenditures for assembly and logistics are required when manufacturing the motor.

It is also possible that the at least one wiper arm features a projection, which creates a frictional connection in the parked position of the at least one wiper arm. This geometry required for the frictional connection in the environment of the at least one wiper arm can be produced, e.g., in a very simple structural manner in the vehicle's water diverter, so that the friction created by the projection in the parked position holds the wiper arm in its parked position even when external forces are acting on the wiper blade. In the case of this variation, the gear, particularly the combination of crank and coupler, does not have to be mounted and delivered in a special position, which makes manufacturing the gear more cost-effective. In addition, no additional parts are required on the wiper motor. The frictional connection with this variation is located advantageously further away from the drive shaft of the wiper arm so that a relatively low frictional force is required to create the required load moment, which counteracts the torque created by the external force acting on the at least one wiper blade. Thus, the lower frictional force also results in a lower frictional wear. The larger the frictional surface is designed to be structurally, the smaller the normal force acting on the frictional surface can be.

If, in the parked position of the at least one wiper arm, the teeth of the toothed wheel engaging in the gear worm feature a raised material application on their tooth flanks, increased friction develops in the parked position between the gear worm and the toothed wheel engaging in the gear worm, and this friction prevents undesirable swiveling of the wiper arm out of the parked position. The additional material application on the tooth flanks is very easy to realize structurally and does not required any additional parts on the wiper motor so that also in this case additional expenditures for assembly and logistics are eliminated when manufacturing the motor.

The toothed wheel engaging in the gear worm can feature a recess on its periphery in which a locking element engages in the parked position. If the locking element is embodied as an angular hook, the required torque, which swivels the wiper arm out of the parked position, can be set very simply via the angle of the hook. If the angle is relatively acute then the required torque is relatively high and if the angle is more obtuse then the required torque is lower. This variation can be used not just on the toothed wheel, but also on all rotating parts of the windshield wiper apparatus.

The locking element can be designed very simply if it is a spring element. The spring element can be manufactured very simply as a punched bent component and can also be mounted very simply, e.g., by engagement in the gear housing. Due to a corresponding embodiment, the punched bent part can also serve as a safety limit stop in one direction of rotation. The required torque that must be applied to swivel the wiper arm out of its parked position can be altered via the pre-tensioning of the spring element.

The at least one device to inhibit the at least one gear can preferably feature a toothed wheel cooperating with a gear worm, whereby the toothed wheel features a recess along a portion of its periphery over which a spring element featuring a projection that projects in the axial direction is tensioned, and the projection can engage in a locking device. As a result, the at least one device to inhibit the at least one gear can be built into an already existing or already used gear housing. In addition, no additional movable parts are required as compared with the known gears without a device for inhibition. The structure of this device to inhibit the at least one gear can be realized with left-rotating as well as with right-rotating drives without additional expenses. Whether the gear is arranged to the right or left of the drive also plays no role.

If the locking device features a limit stop against which the axial projection of the spring element strikes when reaching the parked position of the wiper arm, the limit stop prevents undesirable swiveling of the wiper arm out of the parked position via a positive engagement.

The locking device can be provided with diagonal sliding surfaces in order to permit locking and unlocking of the windshield wiper apparatus without jolts.

The device to inhibit the at least one gear can be realized particularly simply and cost-effectively if the locking device is arranged on the gear housing.

The gear worm can feature a square on a front side, against which a spring element presses in the parked position of the at least one wiper arm. The pressing of the spring element against the square produces an inhibition of the gear so that the wiper arm cannot be swiveled out of its parked position by the external effect of force. In addition, the spring element distorts the gear worm and a motor armature that is possibly connected to it in the bearing locations so that the bearing friction increases as a result and an undesirable swiveling of the wiper arm out of the parked position is also prevented. Since such worm gears with windshield wiper apparatuses as a rule have a step-up ratio of approx. 50 to 1 through 70 to 1 and the inhibition of the gear worm multiplied by the step-up ratio yields the inhibition of the drive shaft of the wiper arm, the inhibition of the gear worm can be correspondingly low in order to prevent the wiper arm from undesirable swiveling.

The spring element acting on the square can be fastened structurally on the toothed wheel or on the gear housing in a very simple manner.

Several exemplary embodiments are explained in the following in more detail on the basis of the enclosed drawings.

They show the following in detail:

FIG. 1A windshield wiper apparatus known from the state of the art.

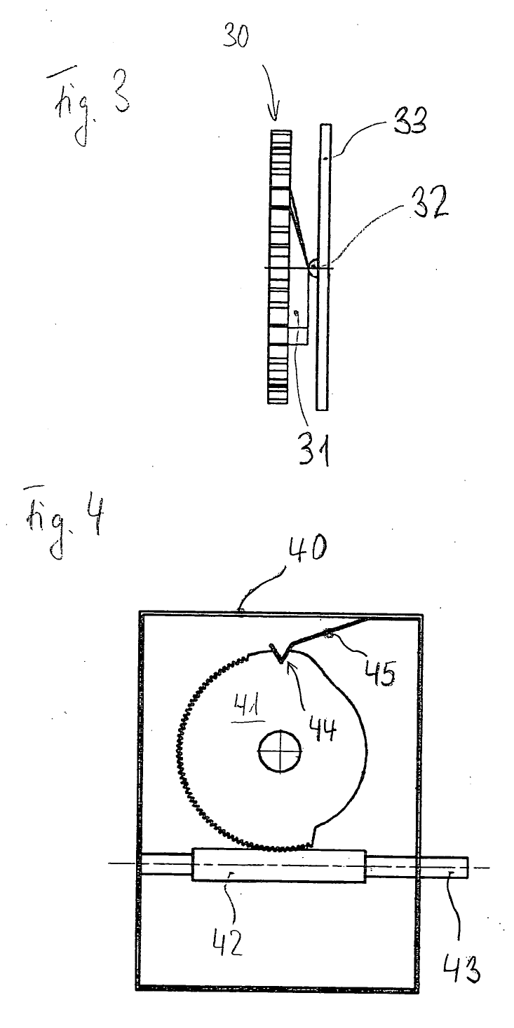

FIG. 2A first embodiment of the device to inhibit a gear.

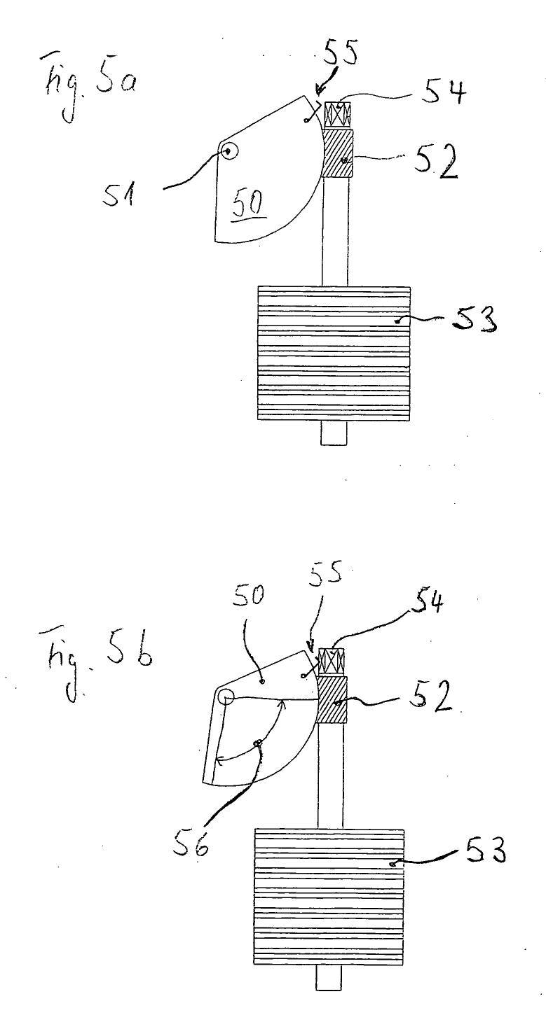

FIG. 3A second embodiment of the device to inhibit a gear.

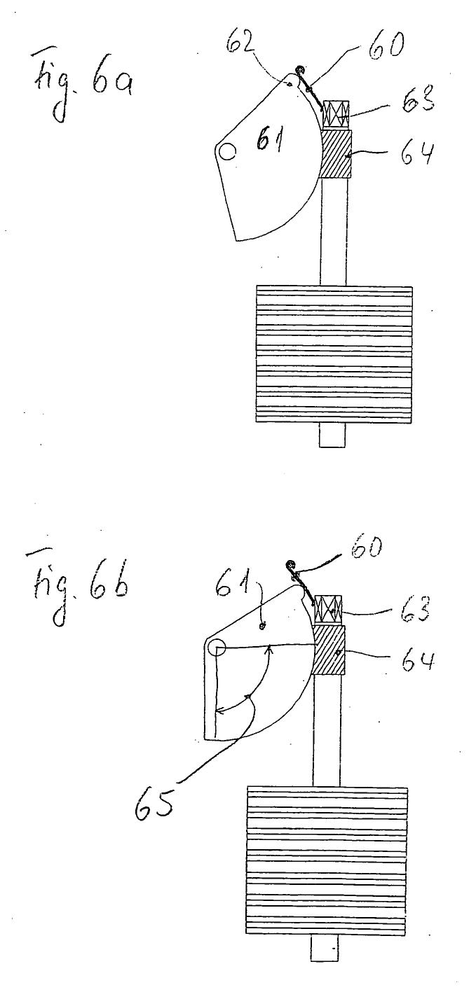

FIG. 4A third embodiment of the device to inhibit a gear.

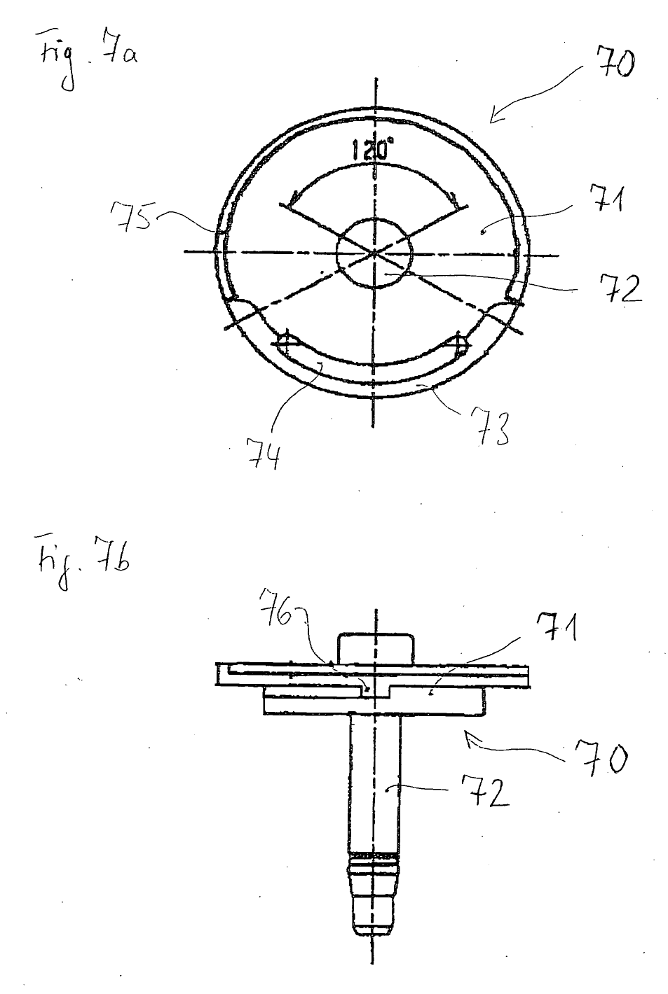

FIG. 5aA fourth embodiment of the device to inhibit a gear before its activation of the inhibiting.

FIG. 5b The fourth embodiment of the device to inhibit the gear in an activated state.

FIG. 6a A fifth embodiment of the device to inhibit a gear during its activation.

FIG. 6b The fifth embodiment of the device to inhibit the gear after its activation.

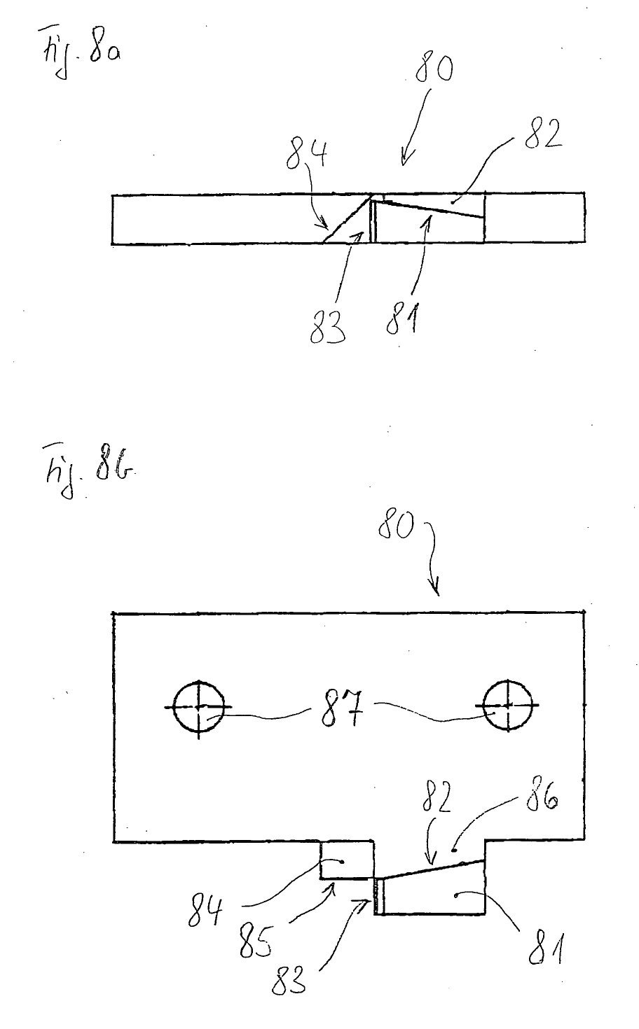

FIG. 7a A view of the front side of a toothed wheel of a sixth embodiment of the device to inhibit the gear.

FIG. 7b A top view of the toothed wheel from FIG. 7a.

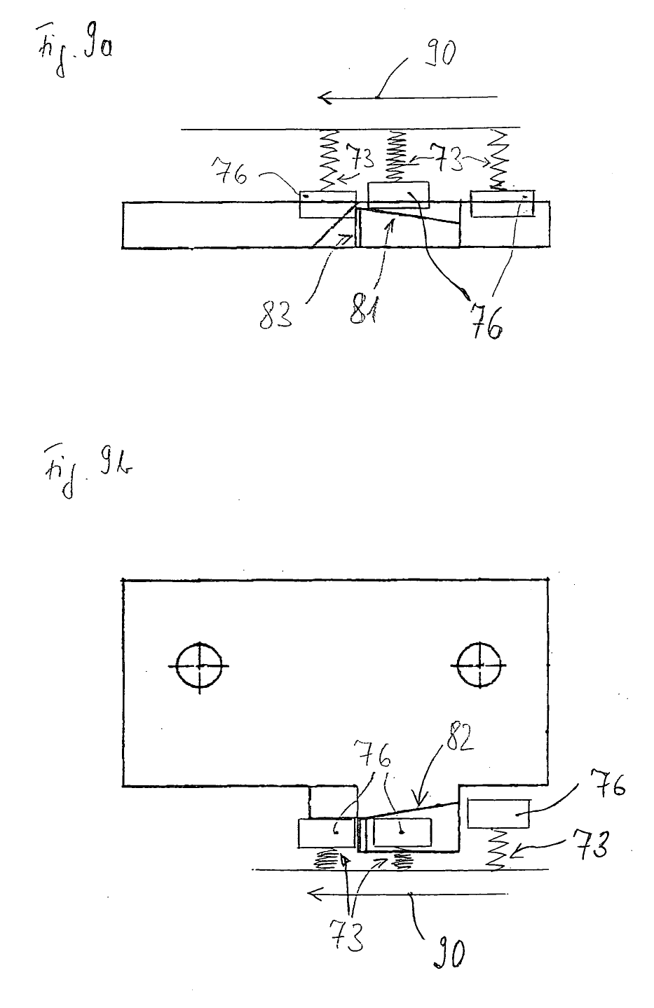

FIG. 8a A top view of a locking device of the sixth embodiment of the device to inhibit the gear.

FIG. 8b A side view of the locking device from FIG. 8a.

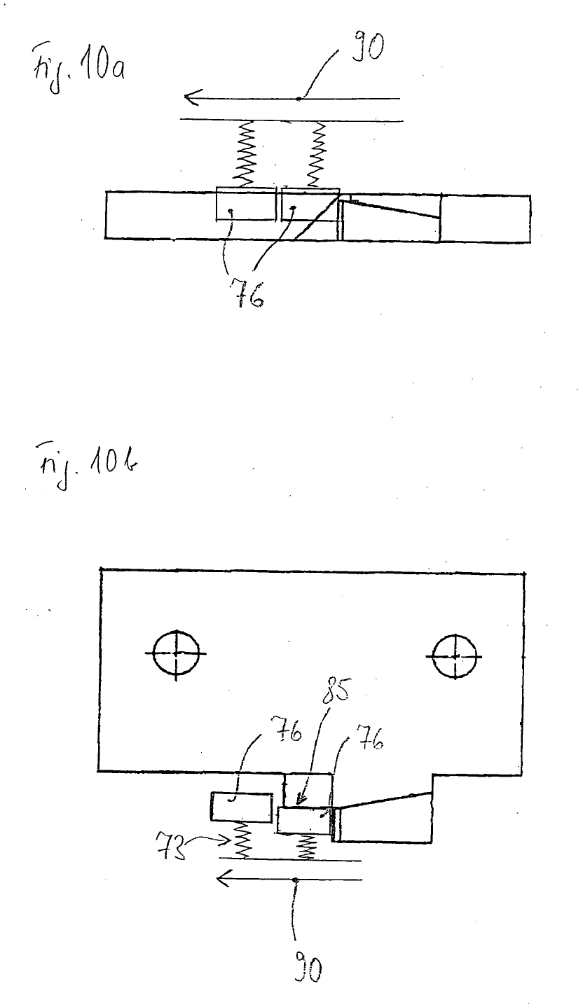

FIG. 9a A top view of the sixth embodiment of the device to inhibit the gear during locking.

FIG. 9b A side view of the sixth embodiment of the device to inhibit the gear during locking.

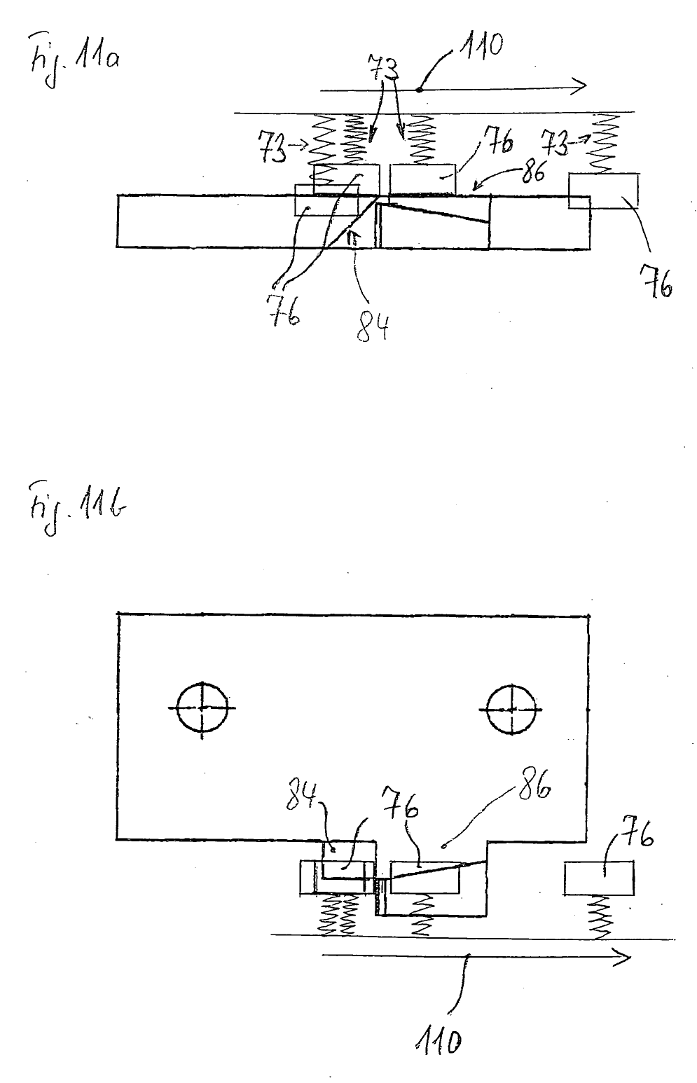

FIG. 10a A top view of the sixth embodiment of the device to inhibit a gear during unlocking.

FIG. 10b A side view of the sixth embodiment of the device to inhibit the gear during unlocking.

FIG. 11a A top view of the sixth embodiment of the device to inhibit a gear in a more advanced stage of unlocking.

FIG. 11b A side view of the sixth embodiment of the device to inhibit a gear in a more advanced stage of unlocking.

FIG. 2 shows a toothed wheel 20, which engages in a gear worm that is not depicted in more detail here. The toothed wheel 20 features teeth 21 and teeth 22. The teeth 22 are provided with a raised material application in the area of their flanks 23. The toothed wheel 20 is situated in the parked position of the wiper arm with its teeth 22 engaged with the gear worm (not shown in greater detail here). Increased friction develops between the toothed wheel 20 and the gear worm in the parked position due to the increased material application on the flanks 23. This increased friction hinders an external force acting on the wiper blade from swiveling the wiper blade out of its parked position.

FIG. 3 shows a toothed wheel 30, which also cooperates with a gear worm that is not shown in greater detail here. The toothed wheel 30 has a projection 31, which rubs on a projection 32 attached to a gear housing 33. This friction prevents the wiper blade from being swiveled out of its parked position by the external effect of force. The projection 31 is advantageously attached only in the area on the toothed wheel 30, which lies opposite from the projection 32 when the wiper blade is in the parked position. The projections 31 and 32 are very easy to realize structurally and do not require any additional parts on the wiper motor. The larger the frictional surfaces of the projections 31 and 32 are, the lower the normal force required for the friction can be, so that the bearing of the toothed wheel 30 in its axial direction does not have to absorb any noticeable stresses.

FIG. 4 shows a gear housing 40, in which a toothed wheel 41 is arranged, which engages in a gear worm 42. The gear worm 42 is connected with a shaft 43, which is driven by a motor (not shown in greater detail here). The toothed wheel 41 features a recess 44 on its periphery, in which a locking element 45 engages. The locking element 45 is advantageously embodied as a spring element, which is connected to the gearing housing 40, e.g., by engagement. As soon as the locking element 45 engages in the recess 44, it prevents the toothed wheel 41 from rotating, if a force acts on the wiper arm from the outside. As a result, the wiper arm can be prevented from undesirable swiveling by the external effect of force.

FIGS. 5a and 5b show a gear worm 52, which cooperates with a toothed wheel 50 embodied as a toothed wheel segment. The gear worm 52 is driven via an armature 53 connected to it, which is a part of a motorized drive. Consequently, the gear worm 52 rotates the toothed wheel 50, thereby driving a wiper arm connected to a shaft 51. A square 54 is connected to the gear worm 52. When the wiper arm moves towards its parked position, the toothed wheel 50 moves with a spring element 55 arranged on it towards the square 54. As soon as the wiper arm reaches its parked position, the spring 55 is pressed against the square 54, thereby preventing the wiper arm in its parked position from swiveling, which is caused by an external force acting on the wiper arm (see FIG. 5b). In addition, the bearing locations of the armature 53 are distorted by pressing the spring element 50 against the square 54 so that the bearing friction in the distorted bearing locations is increased, thereby producing an additional inhibiting effect of the wiper arm from undesirable swiveling of the wiper arm. As soon as the wiper arm is driven out of its parked position by the drive, the spring element moves away from the square 54 so that it relaxes again. This device to inhibit the wiper arm is particularly advantageous if the wiper arm is driven by a reversing drive. The angle 56 shows the reversing angle around which the toothed wheel 50 swivels back and forth when the windshield wiper apparatus is in operation.

FIGS. 6a and 6b show another embodiment starting from the device to inhibit the wiper arm as depicted in FIGS. 5a and 5b. However, in FIGS. 6a and 6b a spring element 60 is not arranged on a toothed wheel 61, but on a gear housing that is not shown in greater detail here. In addition, an actuating cam 62 is arranged on the toothed wheel 61, which presses against the spring element 60 when the wiper arm moves into the parked position and consequently presses the spring element 60 against a square 63 as soon as the parked position is reached (see FIG. 6b). As soon as motor driving a worm wheel 64 moves the wiper arm out of its parked position again, the actuating cam 62 is guided upward along the spring element 60, thereby relaxing the spring element 60. An angle 65 corresponds to the reversing angle around which the toothed wheel 61 swivels back and forth when the windshield wiper apparatus is in operation.

FIGS. 7a, 7b, 8a, and 8b show a toothed wheel 70 and a locking device 80 cooperating with it of another embodiment to inhibit the gear. The toothed wheel 70 features a toothed wheel body 71, which is provided with an axis 72. This is equipped with a spring element 73 along a portion of the periphery of the toothed wheel 70, whereby the spring element 73 is tensioned over a recess 74. A projection 76 is attached on the spring element 73, which extends in the direction of the axis 72. There is toothing 75 along the other portion of the periphery of the toothed wheel 70, which preferably cooperates a gear worm that is not depicted in greater detail in this case. The locking device 80 is preferably arranged above the toothed wheel 70 on a gear housing that is not shown in greater detail here. It features diagonal sliding surfaces 81, 82, and 84 as well as sliding surfaces 85 and 86. The diagonal sliding surfaces 81 turns into a limit stop 83 at its one end. Holes 87 serve to accommodate connecting means in order to fasten the locking device 80 on the gear housing.

FIG. 9a and 9b show the locking process in order to lock the gear when the wiper arm reaches the parked position. The spring 73 and the projection 76 are depicted schematically here in various positions during the locking process. During the locking process, the projection 76 moves in the direction of arrow 90. In doing so, the projection 76 slides along the diagonal sliding surface 81 so that the spring element 73 is tensioned in the axial direction (FIG. 9a). At the same time, the projection 76 slides along the diagonal sliding surface 82, thereby tensioning the spring element 73 in the radial direction (FIG. 9b). After the wiper arm has reached its parked position, the projection 76 reaches the limit stop 83 at the end of the diagonal sliding surface 81. The projection 76 then leaves the diagonal sling surface 81 so that the projection 76 snaps back in the axial direction again so that the spring element 73 relaxes in the axial direction. Because the spring element 73 snaps back in the axial direction, the toothed wheel 70 is prevented by the limit stop 83 from moving back against the locking device so that undesirable swiveling of the wiper arm out of the parked position is precluded. In a locked state the spring element 73 continues to remain tensioned in the radial direction.

To unlock the locked state, the toothed wheel 70 with the projection 76 is first moved in the direction of the arrow 90 (FIGS. 10a and 10b). In doing so, the projection 76 slides along the sliding surface 85. After the end of the sliding surface 85 is reached, the projection 76 snaps back again so that the spring 73 is also relaxed in the radial direction (FIG. 10b). Then the direction of rotation of the toothed wheel 70 is reversed so that the projection 76 moves in the direction of arrow 110 (FIGS. 11a and 11b), which is opposite from the direction of arrow 90. During the unlocking process, the projection 76 slides along the diagonal sliding surface 84, whereby the spring element 73 is tensioned in the axial direction and is therefore guided past limit stop 83. After the projection 76 has reached the end of the diagonal sliding surface 84, it slides along sliding surface 86. After reaching the end of the sliding surface 86, the projection 76 snaps back in the axial direction again, whereby the spring element 73 relaxes in the axial direction (FIG. 11a). The toothed wheel 70 is then no longer in contact with the locking device 80.

1. Windshield wiper apparatus, in particular for a motor vehicle, with a drive motor and at least one gear that drives at least one wiper arm, characterized in that the at least one gear is equipped with at least one device to inhibit the at least one gear.

2. Windshield wiper apparatus according to claim 1, characterized in that the at least one gear features a gear worm (42, 52, 64) in which a toothed wheel (20, 30) engages and the toothed wheel (20, 30) features a projection (31) on at least one front side.

3. Windshield wiper apparatus according to claim 2, characterized in that a housing (33) surrounding the gear also features a projection (32), which, in the parked position of the at least one wiper arm, forms a frictional connection with the projection (31) on the toothed wheel (30).

4. Windshield wiper apparatus according to claim 1, characterized in that, in a parked position of the at least one wiper arm, the teeth (22) of the toothed wheel (20) engaging in the gear worm feature a raised material application on their tooth flanks (23).

5. Windshield wiper apparatus according to claim 1, characterized in that the at least one wiper arm features a projection, which creates a frictional connection in the parked position of the at least one wiper arm.

6. Windshield wiper apparatus according to claim 1, characterized in that the toothed wheel (41) engaging in the gear worm (42) features a recess (44) on its periphery in which a locking element (45) engages in the parked position, or that the toothed wheel (41) features a locking element (45) on its periphery, which engages in a recess (44) in the parked position, which is arranged in particular fixed in the gear housing.

7. Windshield wiper apparatus according to claim 6, characterized in that the locking element (45) is a spring element.

8. Windshield wiper apparatus according to claim 1, characterized in that it features a toothed wheel (70) that preferably cooperates with a gear worm, whereby the toothed wheel (70) features a recess (74) along a portion of its periphery over which a spring element (73) featuring a projection (76) that projects in the axial direction is tensioned, and the projection (76) can engage in a locking device (80).

9. Windshield wiper apparatus according to claim 8, characterized in that the locking device (80) features a limit stop (83).

10. Windshield wiper apparatus according to claim 8, characterized in that the locking device (80) is provided with diagonal sliding surfaces (81, 82, 84).

11. Windshield wiper apparatus according to claim 8, characterized in that the locking device (80) can be arranged on the gear housing.

12. Windshield wiper apparatus according to claim 1, characterized in that the gear worm (52, 64) features a square (54, 63) on a front side, against which a spring element (55, 60) presses in the parked position of the at least one wiper drive.

13. Windshield wiper apparatus according to claim 12, characterized in that the spring element (55, 60) is fastened on the toothed wheel (50, 61) or on the gear housing.
